(19) United States
(12) Patent Application Publication
(10) Pub. No.: US 2026/0329926 A1
(43) Pub. Date: Oct. 22, 2026

(54) LOCATION-BASED REAL-TIME INQUIRY RESPONDING SYSTEMS AND METHODS OF USE THEREOF

(71) Applicants: Peigen Jiang, Sammamish, WA (US); Danni Liu, Sammamish, WA (US); Warren Jibu Xiong, Sammamish, WA (US)

(72) Inventors: Peigen Jiang, Sammamish, WA (US); Danni Liu, Sammamish, WA (US); Warren Jibu Xiong, Sammamish, WA (US)

(21) Appl. No.: 19/183,936

(22) Filed: Apr. 21, 2025

(51) Int. Cl. G06F 16/387; G06F 9/451; H04W 4/029; G06F 16/2458

(52) U.S. Cl. CPC G06F 16/387; G06F 9/451; H04W 4/029; G06F 16/2477

(57) ABSTRACT

A method includes obtaining, by a first client device a location identifier and an associated inquiry, transmitting wirelessly, by the first client device, the location identifier and the associated inquiry to a server computer, identifying, by the server computer, a second client device, the second client device being currently at a vicinity of a location identified by the location identifier, transmitting wirelessly, by the server computer, the inquiry to the second client device while the second client device is still at the vicinity of the location identified by the location identifier, receiving wirelessly, by the server computer, a response to the inquiry from the second client device, and transmitting wirelessly, by the server computer, the response to the first client device if the response is received within a predetermined period after receiving the inquiry.

### BACKGROUND

The present disclosure relates generally to the communication platforms, and, more particularly, to location-based real-time inquiry responding systems and methods of use thereof.

The Internet and the World Wide Web provide a communication platforms that allow people all over the world to communicate with each other and instantly access vast amounts of information. A search engine is a software system that provides hyperlinks to web pages and other relevant information on the Web in response to a user's query. The user inputs a query within a web browser or a mobile app, and the search results are often a list of hyperlinks, accompanied by textual summaries and images. Users also have the option of limiting the search to a specific type of results, such as images, videos, or news. However, the search results are generally prestored information and lack dynamic and real-time response to the user’s query.

Online chat is a one-on-one or one-to-many (group) chat, using tools such as instant messengers and Internet Relay Chat (IRC). Online chat includes web-based applications that allow communication – often directly addressed, but anonymous between users in a multi-user environment. Online chat may address point-to-point communications as well as multicast communications from one sender to multiple receivers. But in online chat, the senders and receivers are generally prearranged and not dynamically based on a particular query.

### BRIEF DESCRIPTION OF THE DRAWING

FIG. 1 illustrates a wireless communication system according to embodiments of the present disclosure.

FIG. 2 illustrates an exemplary smartphone user interface (UI) according to embodiments of the present disclosure.

FIG. 3 is a flowchart illustrating an exemplary client-side operation corresponding to the UI shown in FIG. 2 according to embodiments of the present disclosure.

FIG. 4 illustrates another exemplary smartphone user interface (UI) according to embodiments of the present disclosure.

FIG. 5 is a flowchart illustrating another exemplary client-side operation corresponding to the UI shown in FIG. 4 according to embodiments of the present disclosure.

FIG. 6 illustrates yet another exemplary smartphone user interface (UI) according to embodiments of the present disclosure.

FIG. 7 is a flowchart illustrating yet another exemplary client-side operation corresponding to the UI shown in FIG. 6 according to embodiments of the present disclosure.

FIG. 8 is a flowchart illustrating an exemplary server-side operation according to embodiments of the present disclosure.

FIG. 9 is a flowchart illustrating an exemplary response generating process according to embodiments of the present disclosure.

FIG. 10 illustrates an exemplary smartphone user interface (UI) displaying existing inquiry-and-response pairs according to embodiments of the present disclosure.

FIG. 11 is a flowchart illustrating an exemplary operation of a software application according to embodiments of the present disclosure.

The drawings accompanying and forming part of this specification are included to depict certain aspects of the disclosure. A clearer conception of the disclosure, and of the components and operation of systems provided with the disclosure, will become more readily apparent by referring to the exemplary, and therefore non-limiting, embodiments illustrated in the drawings, wherein like reference numbers (if they occur in more than one view) designate the same elements. The disclosure may be better understood by reference to one or more of these drawings in combination with the description presented herein.

### DESCRIPRION

The present disclosure details location-based real-time inquiry response systems and methods of use thereof. The inquiry response systems utilize the global positioning system (GPS) and optional wireless carrier provided location estimation to determine locations of smartphones that are logged in the system, so that inquiries can be sent to smartphones at a specific location to solicit responses therefrom. Preferred embodiments of the present disclosure will be described thereafter with reference to the attached drawings.

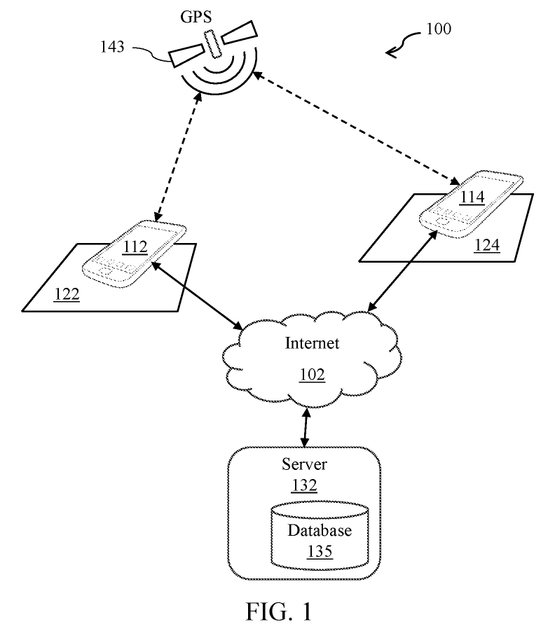

FIG. 1 illustrates a wireless communication system 100 according to embodiments of the present disclosure. The wireless communication system 100 includes two exemplary smartphones 112 and 114, each equipped with a GPS tracking device for receiving location information from a GPS satellite 143. In embodiments, locations of the exemplary smartphones 112 and 114 can also be detected by wireless carriers, and provided to location tracking application on the smartphones 112 and 114. As shown in FIG. 1, the smartphone 112 is at a location 122; and the smartphone 114 is at a location 124. The smartphones 112 and 114 may move over time, their respective GPS tracking device can periodically update their location information.

In embodiments, a full-stack software application (app) is employed to implement the wireless communication system 100. A client component of the app is installed in both the smartphones 112 and 114; while a server component of the full-stack software application is deployed in the server 132 which includes a database 135. The app communicates between the smartphones 112 or 114 and the server 132 via the internet 102. In embodiments, the connection of the internet 102 is provided by wireless communication services.

In an embodiment, the client component of the app is browser based that runs directly in a web browser without requiring installation. The browser based app is easily accessible across devices and typically does not take up storage space. However, the browser based app may depend on a reliable internet connection and browser compatibility.

In another embodiment, the client component of the app is a downloadable one that is installed on the smartphone 112 and 114. The downloadable app often provides more robust features or offline capabilities. The downloadable app may require storage space and regular updates but can deliver smoother, optimized experience tailored to specific devices.

In embodiments, the server component of the app is responsible for handling various crucial functions behind the scenes. For example, the server component of the app serves such roles as database management, business logic, application programming interface (API), authentication and authorization, server-side rendering, integration with third-party services and security measures. The database management includes storing, retrieving and managing data, like user information, app content, or transaction records. The database management also ensures that data persists even after the app is closed. The business logic refers to enforcing the rules and workflows of the app, such as processing payments, validating user input, or generating recommendations. The API facilitates communication between the server and client-side by sending and receiving data securely and effectively. The authentication and authorization manage user access, ensuring that only authorized users can perform specific actions or view certain data. In the server-side rendering, some applications generate views or pages dynamically and send them to the client, improving performance and search engine optimization (SEO). The integration with third-party services refers to connecting to external services, such as payment gateways, email servers, or cloud storage, to extend the app’s capabilities. The security measures refer to handling encryption, protecting against attacks, and ensuring data integrity.

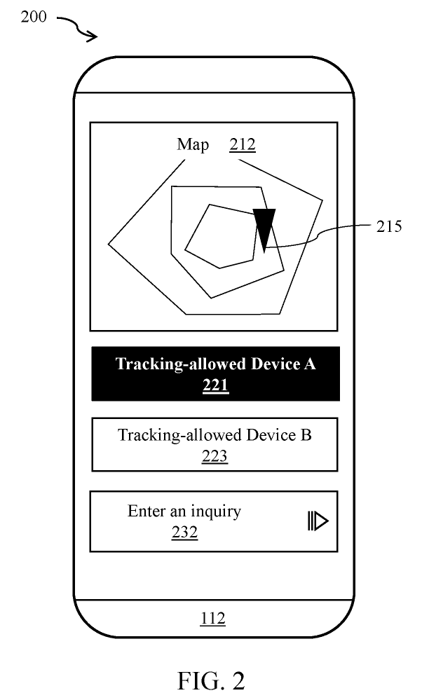

FIG. 2 illustrates an exemplary smartphone user interface (UI) 200 according to embodiments of the present disclosure. The UI 200 is exemplary displayed in the smartphone 112 and is generated by the client component of the app that is installed in the smartphone 112. The UI 200 includes a map 212, two selection buttons 211 and 223, an input box 232. The two selection buttons 221 and 223 represent a tracking-allowed device A and a tracking-allowed device B, respectively. Here, the “tracking-allowed” refers to that the device A or device B allows the app to track the location of the respective device via GPS, wireless services or both. In an embodiment, the tracking is only allowed when the smartphone 112 is logged in to the client component of the app. In another embodiment, the tracking is allowed whenever the smartphone 112 is powered on.

As shown in FIG. 2, for example, when the button 221 for device A is selected, a current location 215 of device A is then displayed in the map 212. Similarly, when button 223 for device B is selected, a current location of device B is then displayed in the map 212.

As shown in FIG. 2, a user can enter an inquiry in the input box 232. As device A is selected, the inquiry pertains to device A’s location 215. The inquiry can be either text-based, voice-based or both.

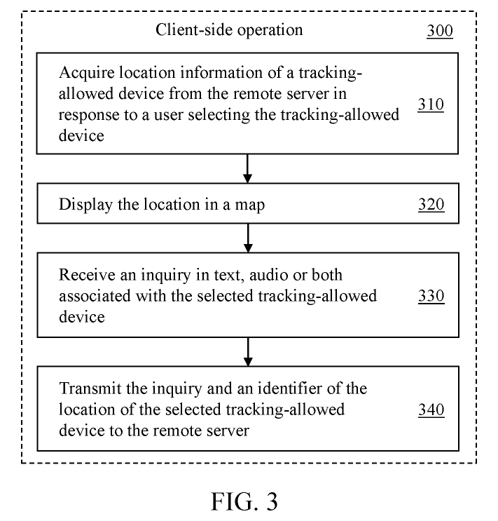

FIG. 3 is a flowchart illustrating an exemplary client-side operation 300 corresponding to the UI 200 shown in FIG. 2 according to embodiments of the present disclosure. The operation 300 is performed by the client component of the app installed in the exemplary smartphone 112 and includes blocks 310-340 as described below.

In block 310, the client component of the app acquires location information of a tracking-allowed device, e.g., device A represented by the button 221 shown in FIG. 2, from the remote server 132 in response to a user selecting the tracking-allowed device.

In block 320, the client component of the app displays the location on a map on the smartphone 112.

In block 330, the client component of the app receives an inquiry in text, audio or both associated with the selected tracking-allowed device.

In block 340, the client component of the app transmits the inquiry and an identifier of the location of the selected tracking-allowed device to the remote server 132 shown in FIG. 1.

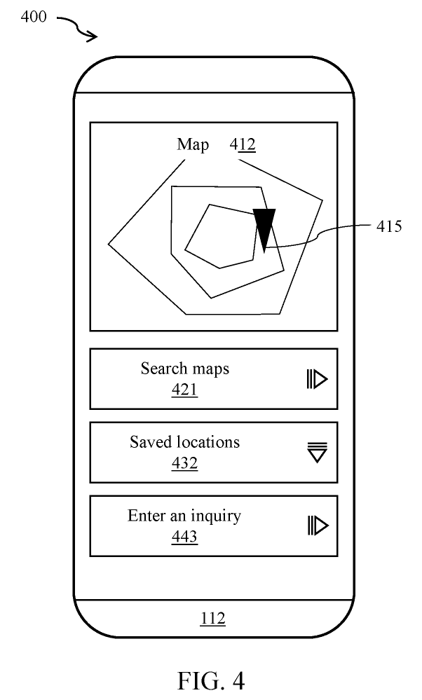

FIG. 4 illustrates another exemplary smartphone user interface (UI) 400 according to embodiments of the present disclosure. The UI 400 is exemplary displayed in the smartphone 112 and is generated by the client component of the app that is installed in the smartphone 112. The UI 400 includes a map 412, a search box 421, a selection box 432 and an input box 443. The search box 421 is for a user to enter a location search term which is transmitted, by the client component of the app, to a map service for identifying a location corresponding to the location search term. The identified location 415 is then displayed on the map 412 as shown in FIG. 4. Alternatively, the user can press the selection box 432 to show a drop-down list of saved locations to choose from. A selected saved location is then displayed on the map 412.

As shown in FIG. 4, the user can enter an inquiry in text, voice or both into the input box 443. The entered inquiry is associated with the location 415 displayed on the map 412.

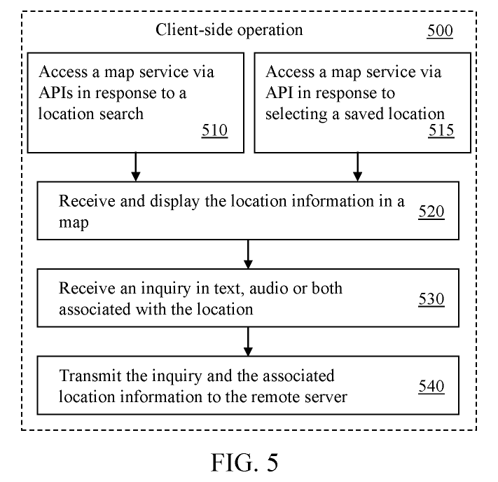

FIG. 5 is a flowchart illustrating another exemplary client-side operation 500 corresponding to the UI 400 shown in FIG. 4 according to embodiments of the present disclosure. The operation 500 is performed by the client component of the app installed in the exemplary smartphone 112 and includes blocks 510-540 as described below.

In block 510, the client component of the app accesses a map service via APIs in response to a location search. The location search, for example, is entered in the search box 421 shown in FIG. 4.

In block 515, alternatively, the client component of the app accesses the map service via API in response to selecting a saved location. The saved location is selected from a dropdown list as a result of a user pressing the select box 432 shown in FIG. 4.

In block 520, the client component of the app receives a search result, i.e., the location 415 in response to the location search in block 510 or the saved location in block 515, from the map service, and the location 415 is displayed on the map 412 as shown in FIG. 4.

In block 530, the client component of the app receives an inquiry in text, audio or both associated with the location.

In block 540, the client component of the app transmits the inquiry and associated location information to the remote server 132 shown in FIG. 1.

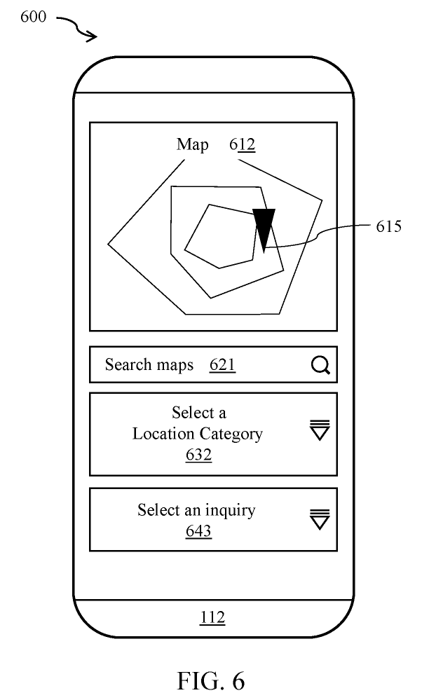

FIG. 6 illustrates yet another exemplary smartphone user interface (UI) 600 according to embodiments of the present disclosure. The UI 600 is exemplary displayed in the smartphone 112 and is generated by the client component of the app that is installed in the smartphone 112. The UI 600 includes a map 612, a search box 621, a selection box 632 and an input box 643. The search box 621 is for a user to enter a location search term which is transmitted, by the client component of the app, to a map service for identifying a location corresponding to the location search term. The identified location 615 is then displayed on the map 612 as shown in FIG. 6. When a user presses the selection box 632, a dropdown list which shows a plurality of location categories will appear. The plurality of location categories exemplarily includes “restaurant”, “store”, “theater” or “stadium”. In embodiments, the plurality of location categories is dynamically determined by the identified location 615. For exemplary, if the identified location 615 is in a vicinity of a city center, the plurality of location categories will only have, for example, “office” and “store”. When a location category is selected by the user on the UI 600, the selected location category will be associated with the identified location 615.

As shown in FIG. 6, the user can enter an inquiry in text, voice or both into the input box 643. The entered inquiry will be associated with both the identified location 615 and the selected location category.

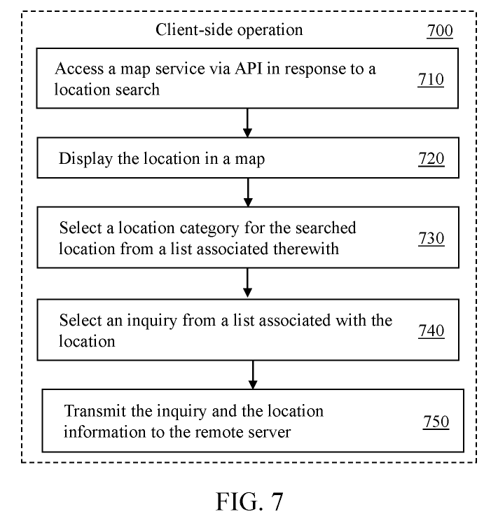

FIG. 7 is a flowchart illustrating yet another exemplary client-side operation 700 corresponding to the UI 600 shown in FIG. 6 according to embodiments of the present disclosure. The operation 700 is performed by the client component of the app installed in the exemplary smartphone 112 and includes blocks 710-750 as described below.

In block 710, the client component of the app accesses a map service via APIs in response to a location search. The location search, for example, is entered in the search box 621 shown in FIG. 6.

In block 720, the client component of the app receives a search result, i.e., the identified location 615 in response to the location search in block 710 from the map service, and the identified location 615 is displayed on the map 612 as shown in FIG. 6.

In block 730, the client component of the app receives a selection of a location category from a dropdown list for the identified location 615. The location category becomes a part of location information that includes an identifier, such as coordinates, of the location.

In block 740, the client component of the app receives an inquiry in text, audio or both associated with the identified location 615.

In block 750, the client component of the app transmits the inquiry and associated location information (identifier of the location and the location category) to the remote server 132 shown in FIG. 1.

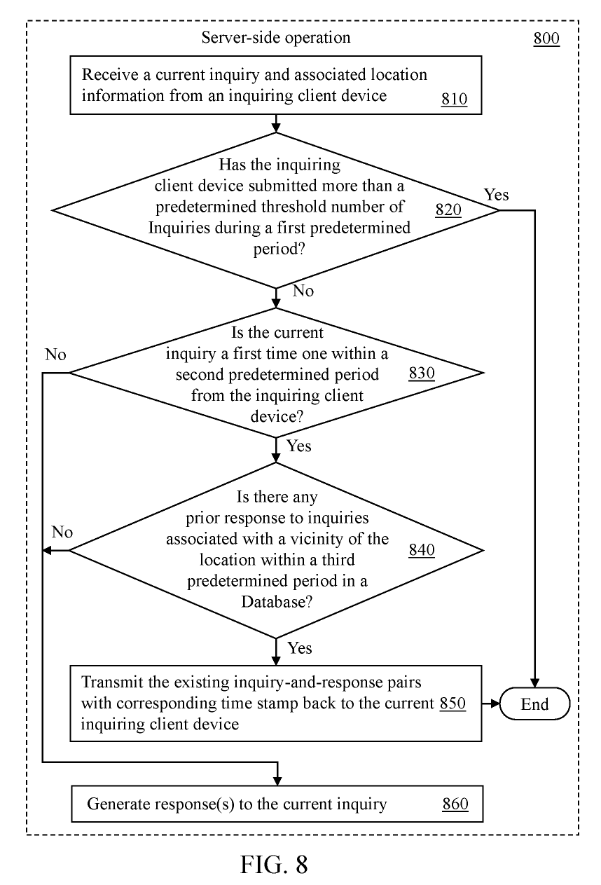

FIG. 8 is a flowchart illustrating an exemplary server-side operation 800 according to embodiments of the present disclosure. The server-side operation 800 begins with receiving a current inquiry and associated location information from an inquiring client device in block 810. In a subsequent block 820, the server-side operation 800 checks if the inquiring client device has submitted more than a predetermined threshold number of inquiries during a first predetermined period, for example, 5 inquiries in a minute. This operational step is to prevent the server 132 from being inundated by a particular client device 112.

As shown in FIG. 8, if the number of inquiries exceeds the threshold, the server-side operation 800 will terminate and not respond to the current inquiring client device. If the number of inquiries is below the threshold, the server-side operation 800 will proceed to block 830 to check if the current inquiry is a first time inquiry received by the server 132 within a second predetermined period from the current inquiring client device. The second predetermined period may be set at 10 minutes. If the inquiry is the first time inquiry, the server-side operation 800 will further check its database to see if there are any prior responses to inquiries associated with a vicinity of the inquired location associated with the current inquiry within a third predetermined period in block 840. As an example, the vicinity of the location can be defined as within a 50 yard radius of the inquired location; and the third predetermined period is 20 minutes. If there is already an existing response within the third predetermined period in the vicinity of the inquired location, the server-side operation 800 transmits the response paired with its inquiry and a time stamp back to the current inquiring client device in block 850. As an example, the time stamp is a time when the existing response is received by the server 132. As another example, the time stamp is a time when an inquiry corresponding to the existing response is received.

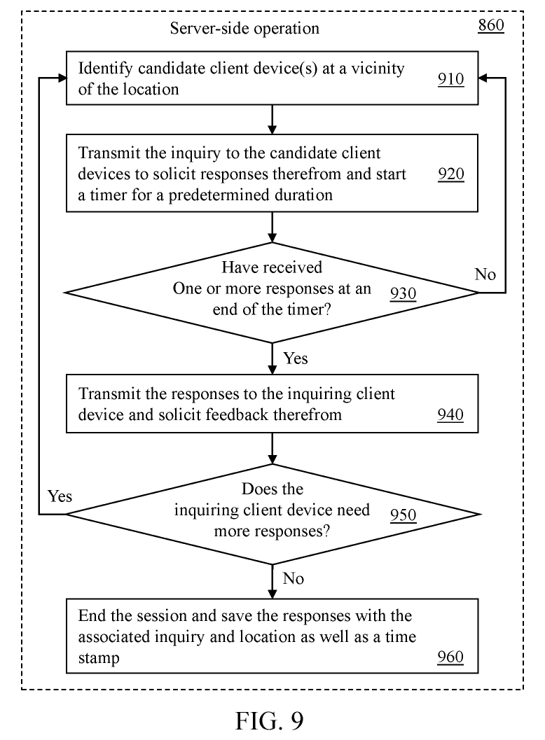

As shown in FIG. 8, if the current inquiry is not a first time one checked out in block 830, or there is no prior response checked out in block 840, the server-side operation 800 will proceed to block 860 to generate response(s) to the current inquiry as depicted in FIG. 9.

FIG. 9 is a flowchart illustrating an exemplary response generating process 860 according to embodiments of the present disclosure. The process 860 includes exemplary blocks 910-960 as described below.

In block 910, the server component of the app identifies candidate client device(s) at a vicinity of the location received in block 810 shown in FIG. 8. In embodiments, the candidate client device(s) have their location-tracking feature turned on so that the server component of the app knows where they are. The vicinity of the location may be defined as within 50 yard radius of the location spot. In embodiments, the radius is adjustable. For example, when there is no candidate client device within 50 yard radius, the search can expand to 60 yard radius, and so on and so forth until a candidate client device emerges or a preset maximum radius, e.g., 100 yard radius, is reached. In embodiments, the number of candidate client devices has an upper limit, for example, 5. If there are more than 5 client devices within the vicinity of the location, the server component of the app will choose 5 of them as candidate client devices. A less frequently chosen client device will have a higher chance of being selected as a candidate.

In block 920, the server component of the app transmits the inquiry received in block 810 shown in FIG. 8 to the candidate client devices to solicit responses therefrom and starts a timer for a predetermined duration. In embodiments, the predetermined duration is 3 minutes.

In block 930, the server component of the app awaits response(s) from the candidate client devices. When the timer ends without receiving a response, the server component of the app returns to block 910 to identify different candidate client device(s). On the hand, when the timer ends, the server receives one or more responses, the server component of the app will proceed to block 940.

In block 940, the server component of the app transmits the received response(s) to the inquiring client device and solicits feedback therefrom.

In block 950, if the inquiring client device indicates in a feedback that more responses are needed, the server component of the app goes back to block 910 to identify different candidate client device(s). If the inquiring client device indicates in a feedback that no more response is needed, the server component of the app proceed to block 960.

In block 960, the server component of the app ends the session and saves the response(s) with the associated inquiry and location as well as a time stamp in a database. In an embodiment, the time stamp is a time when the response is received by the server component of the app. In another embodiment, the time stamp is a time when the inquiry is received by the server component of the app.

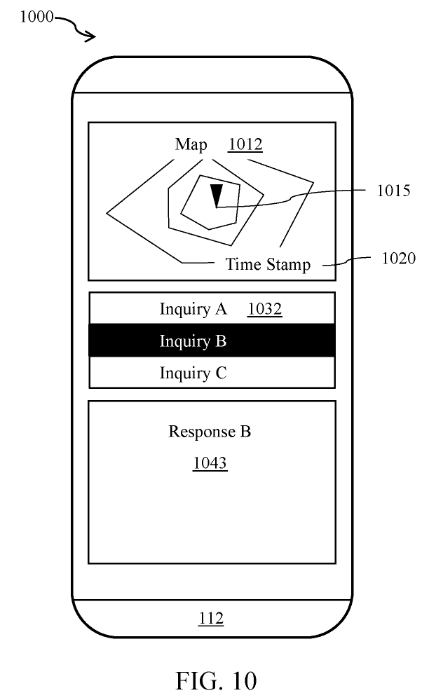

FIG. 10 illustrates an exemplary smartphone user interface (UI) 1000 displaying existing inquiry-and-response pairs according to embodiments of the present disclosure. The UI 1000 corresponds to or is a result of block 850 shown in FIG. 8.

As shown in FIG. 10, there are three prior inquiries, inquiry A-C displayed in a list box 1032 at location 1015 shown on map 1012 on the UI 1000. Each of the inquiry A-C has response(s) within the third predetermined period. As an example, when a user selects inquiry B, corresponding response B will be displayed in text box 1043. In embodiments, the response B includes one or more responses.

As shown in FIG. 10, a time stamp 1020 is also displayed on the UI 1000. The time stamp 1020 is associated with the selected inquiry B. When a different inquiry is selected, a different corresponding time stamp will be displayed.

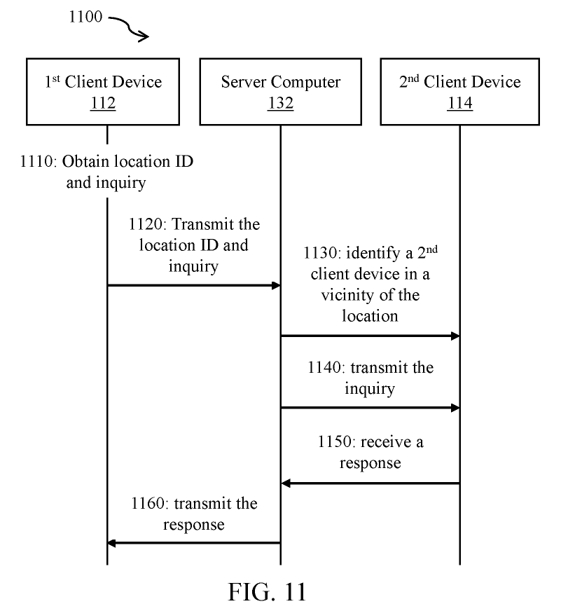

FIG. 11 is a flowchart illustrating an exemplary operation 1100 of a software application according to embodiments of the present disclosure. A client component of the software application is installed in the exemplary first client devices 112 and the second client devices 114. A server component of the software application is deployed in the server computer 132. The operation 1100 of the software application includes steps 1110-1160 described below.

In step 1110, the first client device, executing the client component of the software application, obtains a location identifier and an associated inquiry by providing UI elements for a user to enter such information.

In step 1120, the first client device, executing the client component of the software application, transmits the location identifier and the associated inquiry to the server computer 132.

In step 1130, the server computer 132 identifies a second client device 114 in a vicinity of a location identified by the location identifier.

In step 1140, the server computer 132 transmits the inquiry to the second client device 114.

In step 1150, the server computer 132 receives a response corresponding to the inquiry from the second client device 114.

In step 1160, the server computer 132 transmits the response to the first client device 112.

Although the disclosure is illustrated and described as embodied in one or more specific examples, it is nevertheless not intended to be limited to the details shown, since various modifications and structural changes may be made therein without departing from the spirit of the disclosure and within the scope and range of equivalents of the claims. Accordingly, it is appropriate that the appended claims be construed broadly and, in a manner, consistent with the scope of the disclosure, as set forth in the following claims.

What is claimed is:

1. A method comprising:
obtaining, by a first client device executing a client component of a software application, a location identifier and an associated inquiry;
transmitting wirelessly, by the first client device executing the client component of the software application, the location identifier and the associated inquiry to a server computer executing a server component of the software application;
identifying, by the server computer executing the server component of the software application, a second client device having installed the client component of the software application, the second client device being currently at a vicinity of a location identified by the location identifier;
transmitting wirelessly, by the server computer executing the server component of the software application, the inquiry to the second client device
receiving wirelessly, by the server computer executing the server component of the software application, a response to the inquiry from the second client device;
transmitting wirelessly, by the server computer executing the server component of the software application, the response to the first client device if the response is received within a predetermined period after receiving the inquiry;
receiving wirelessly, by the server computer executing the server component of the software application, a feedback corresponding to the response from the first client device, the feedback indicating a request for extending the inquiry to other client devices;
identifying, by the server computer executing the server component of the software, upon receiving the feedback, a separate client device having installed the client component of the software application, the separate client device being currently at the vicinity of the location identified by the location identifier; and
transmitting wirelessly, by the server computer executing the server component of the software application, the inquiry to the separate client device.

2. The method of claim 1, further comprising:
displaying, by the first client device executing the client component of the software application, a user interface (UI) element for selecting a third client device having installed the client component of the software application; and
obtaining, by the first client device executing the client component of the software application, the location identifier from the server computer in response to a selection of the UI element.

3. The method of claim 1, further comprising:
displaying, by the first client device executing the client component of the software application, a user interface (UI) element for searching a map; and
obtaining, by the first client device executing the client component of the software application via an application programming interface (API), the location identifier from a remote mapping service provider in response to an entry in the UI element.

4. The method of claim 1, further comprising:
displaying, by the first client device executing the client component of the software application, a user interface (UI) element for selecting a previously saved location; and
obtaining, by the first client device executing the client component of the software application, the location identifier from the server computer in response to a selection of the UI element.

5. The method of claim 1, further comprising:
displaying, by the first client device executing the client component of the software application, a user interface (UI) element for selecting a predetermined location category; and
transmitting wirelessly, by the first client device executing the client component of the software application in response to a selection of the UI element, the predetermined location category along with the location identifier and the associated inquiry to the server computer.

6. The method of claim 1, further comprising:
incrementing, by the server computer executing the server component of the software application, a counter dedicated to the first client device by a predetermined integer in response to receiving the location identifier and the associated inquiry, the counter having a preset value of zero;
comparing, by the server computer executing the server component of the software application, the counter to a predetermined threshold; and
allowing, by the server computer executing the server component of the software application, identifying the second client device if the counter is lower than the predetermined threshold.

7. The method of claim 1, further comprising storing, by the server computer executing the server component of the software application, the location identifier,the associated inquiry and the corresponding response with a time stamp in a database.

8. The method of claim 7, wherein the time stamp is a time of receiving the location identifier by the server computer.

9. The method of claim 7, wherein the time stamp is a time of receiving the response by the server computer.

10. The method of claim 1, further comprising:
checking, by the server computer executing the server component of the software application, a counter dedicated to the first client device, a content of the counter being a number of inquiries transmitted from the first client device during a predetermined period;
identifying, by the server computer executing the server component of the software application, the second client device if the content of the counter is less than a predetermined number.

11. The method of claim 1, wherein the predetermined period is provided by the first client device.

12. The method of claim 1, further comprising displaying, by the first client device executing the client component of the software application, a user interface (UI) element for obtaining the inquiry.

13. The method of claim 12, wherein the UI element is a text input box, a voice recorder or both.

14. A method comprising:
obtaining, by a first client device executing a client component of a software application,a location identifier and an associated first inquiry;
transmitting wirelessly, by the first client device executing the client component of the software application, the location identifier and the associated first inquiry to a server computer executing a server component of the software application;
obtaining, by the server computer executing the server component of the software application, a prior response and an associated prior inquiry with a time stamp from a database, the time stamp being a time less than a first predetermined period before transmitting the location identifier;
transmitting wirelessly, by the server computer executing the server component of the software application, the prior response and the associated prior inquiry with the time stamp to the first client device;
transmitting wirelessly, by the first client device executing the client component of the software application, the location identifier and an associated second inquiry to the server computer after receiving the prior response;
identifying, by the server computer executing the server component of the software application, a second client device having installed the client component of the software application, the second client device being currently at a vicinity of a location identified by the location identifier;
transmitting wirelessly, by the server computer executing the server component of the software application, the second inquiry to the second client device while the second client device is still at the vicinity of the location identified by the location identifier;
receiving wirelessly, by the server computer executing the server component of the software application, a current response to the second inquiry from the second client device; and
transmitting wirelessly, by the server computer executing the server component of the software application, the current response to the first client device if the current response is received within a second predetermined period after receiving the second inquiry.

15. The method of claim 14, wherein the first and the second inquiry are the same.

16. The method of claim 14, further comprising:
displaying, by the first client device executing the client component of the software application, a user interface (UI) element for searching a map; and
obtaining, by the first client device executing the client component of the software application via an application programming interface (API), the location identifier from a remote mapping service provider in response to an entry in the UI element.

17. The method of claim 14, further comprising:
displaying, by the first client device executing the client component of the software application, a user interface (UI) element for selecting a previously saved location;and obtaining, by the first client device executing the client component of the software application, the location identifier from the server computer in response to a selection of the UI element.

18. The method of claim 14, further comprising storing, by the server computer executing the server component of the software application, the location identifier, the associated second inquiry and the corresponding current response with a time stamp in a database.

19. The method of claim 18, wherein the time stamp is a time of receiving the location identifier by the server computer or a time of receiving the current response by the server computer.

20. The method of claim 14, further comprising:
checking, by the server computer executing the server component of the software application, a counter dedicated to the first client device, a content of the counter being a number of inquiries transmitted from the first client device during a third predetermined period;
identifying, by the server computer executing the server component of the software application, the second client device if the content of the counter is less than a predetermined number.
